(19) United States
(12) Patent Application Publication
(10) Pub. No.: US 2023/0115064 A1
(43) Pub. Date: Apr. 13, 2023

(54) SECURING DATA TRANSMISSIONS USING SPLIT MESSAGES

(71) Applicant: Dell Products L.P., Round Rock, TX (US)

(72) Inventor: Victor Salamon, Edmonton (CA)

(21) Appl. No.: 17/490,042

(22) Filed: Sep. 30, 2021

(51) Int. Cl. H04L 12/861; H04L 12/801; H04L 29/06

(52) U.S. Cl. CPC H04L 49/9057; H04L 47/34; H04L 49/9042; H04L 63/0227

(57) ABSTRACT

Methods, apparatus, and processor-readable storage media for securing data transmissions using split messages are provided herein. An example computer-implemented method includes obtaining a plurality of messages including content to be transmitted from a host device to at least one storage system; dividing each of the plurality messages into two or more corresponding parts; and transmitting (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system.

### FIELD

The field relates generally to information processing systems, and more particularly to protecting data in such systems.

### BACKGROUND

Generally, storage systems have security measures that protect data at the presentation and physical layers. Such security measures are effective against software-based attacks, but fail to protect against physical attacks, such as when an attacker has physical access to the storage network. As such, many organizations rely on inefficient and costly security measures to protect sensitive devices from physical attacks.

### SUMMARY

Illustrative embodiments of the disclosure provide techniques for securing data transmissions using split messages. An exemplary computer-implemented method includes obtaining a plurality of messages comprising content to be transmitted from a host device to at least one storage system; dividing each of the plurality messages into two or more corresponding parts; and transmitting (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system.

Illustrative embodiments can provide significant advantages relative to conventional data protection techniques. For example, challenges associated with protecting data against physical attacks are overcome in one or more embodiments by partitioning individual messages into multiple parts and sending the multiple parts across different packets, wherein information for reassembling the multiple parts is identified in a manner known to the at least one storage system.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for securing data transmissions using split messages in an illustrative embodiment.

FIG. 2 shows a diagram of techniques for splitting and distributing messages across different packets in an illustrative embodiment.

FIG. 3 shows a diagram of techniques for distributing packets across multiple network paths in an illustrative embodiment.

FIG. 4 shows a flow diagram of a process for securing data transmissions using split messages in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources. Numerous different types of enterprise computing and storage systems are also encompassed by the term “information processing system” as that term is broadly used herein.

Data centers can implement security measures to protect its data at a software level but remain vulnerable to attackers that have physical access to the storage network. For example, a physical attack may be in the form of a man-in-the-middle attack via a wiretap or splitter. For such attacks, the attacker can gain access to a Fibre Channel or optical switch and carry out the attack by at least one of: (i) optically splitting the messages to siphon off copies of the transmitted messages; and (ii) capturing the messages, intentionally altering them, and forwarding the altered versions. An attack of an optical nature is just one example of an attack, any format can be physically attacked this way.

Physical attacks often go undetected at all software levels, especially when the attacker installs the attack methods non-disruptively; gains access to existing equipment installed in the system (e.g., the attacker may attack Fibre Channel frame analyzer devices installed in a storage area networks (SAN) for Fibre Channel network tracing, monitoring, and analysis); or carries out the attack in a physical security domain outside of the control of the application (e.g., in connections between data centers, attacks on a wide area network (WAN), between hosts, and/or storage arrays from one data center cross-connected to storage at a different data center).

Existing techniques that attempt to address these problems generally include protecting physically protecting sensitive devices that store data, such as by using locks, security guards, fences, etc.

For storage systems, data protection techniques are generally limited to protecting data at the presentation or data link layer of the Open Systems Interconnection (OSI) model (which is a conceptual framework that splits the communications between a computing system into seven different abstraction layers, namely, Physical, Data Link, Network, Transport, Session, Presentation, and Application). Such techniques include, for example, role-based access control and login authentication for administrative functions only (occurring at the session layer); encrypting the data itself on the host, and then sending the encrypted data to the storage array (occurring at the presentation layer); login and authentication to the host and application accessing the data (occurs at the session layer); and LUN zoning and/or masking for World Wide Names (WWNs) (occurring at the data link layer).

For example, Small Computer System Interface (SCSI) is an unencrypted protocol and leaves a system open to, for example, replay attacks, man-in-the-middle attacks, packet fuzzing, and even cracking attacks if a weak password or encryption algorithm is chosen. It is to be appreciated that the SCSI transmission protocol is used merely as an example, and embodiments described herein are also applicable to other data storage transmission protocols.

Currently, masking and zoning are the only software solutions for securing access to the ports of a SCSI device. However, these techniques are essentially a form of whitelisting or blacklisting, and therefore, can be circumvented by simply changing the WWN of a device that is not allowed to connect, to the WWN of a device that can connect to the SCSI device. It is trivial to change the WWN of a device, and furthermore, these mitigations cannot protect the data flowing between hosts and data storage arrays from physical attacks, such as a wiretapping attack. Other approaches include securing fiber channel fabrics via encryption, and authenticating storage array access and encrypting messages at a SCSI level.

However, each of the approaches above suffer from one or more disadvantages. For example, an attacker who gains physical access to a network can still obtain and alter full and/or contiguous messages exchanged over a SAN or WAN, as such messages are still sent as semantically consistent and physically contiguous. Also, encrypting messages introduces performance tradeoffs, and so the channel and/or messages may not be encrypted, or they may be encrypted with a simple encryption scheme.

Even if encryption is used, once a malicious party has access to a copy of the message, they can setup further attacks, security breaches, and even intentional data corruption or subversion. For example, the attacker can use advanced technologies to reverse-engineer the original messages. With their own copy of the messages, the attacker can employ repeated testing of the encryption, without danger of being detected through the repeated testing or other suspicious activities. The attacker can use combinations of different methods, such as brute-force at large scale, and/or entire language dictionaries of words and known phrases, perhaps matching to other social clues/keywords about a targeted user. To speed up this undetected offline attack, the attacker can use supercomputers, distributed computing including botnets of hosts that were previous compromised, and/or emerging technologies such as quantum computing. The shorter the original messages are, and the more standard or patterned the content is, the easier the encryption scheme will be to reverse. For example, if a message includes a credit card number and a format of credit card in the message can be recognized, then the message can be targeted using specific decryption methods that take that format into consideration. A single physical point of attack can capture all messages in the communication messages.

Some attempts to fill these security gaps include adding additional security layers on top of encryption. For example, in data storage, a zero-knowledge architecture relates to an architecture where data are not all stored in one place. However, zero-knowledge architectures apply only to the situation where the data are distributed across multiple storage locations.

Accordingly, illustrative embodiments herein describe improved techniques for securing data transmissions using split messages.

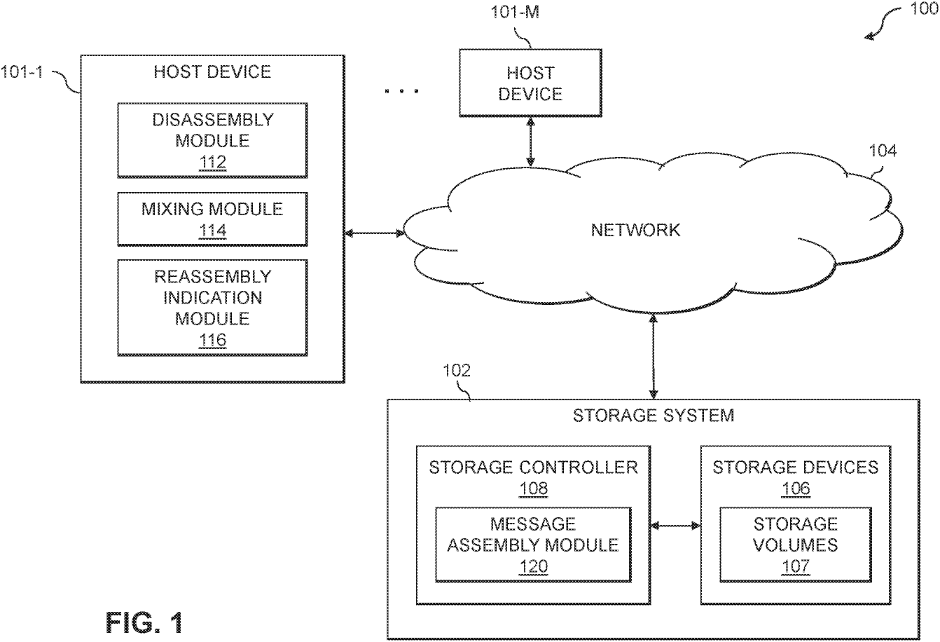

FIG. 1 shows an information processing system 100 configured in accordance with an illustrative embodiment. The information processing system 100 comprises a plurality of host devices 101-1, ... 101-M, collectively referred to herein as host devices 101 and a storage system 102. The host devices 101 and the storage system 102 are configured to communicate with each other over a network 104.

The host devices 101 illustratively comprise servers or other types of computers of an enterprise computer system, cloud-based computer system or other arrangement of multiple compute nodes associated with respective users.

For example, the host devices 101 in some embodiments illustratively provide compute services such as execution of one or more applications on behalf of each of one or more users associated with respective ones of the host devices. Such applications illustratively generate input-output (IO) operations that are processed by the storage system 102. The term “input-output” as used herein refers to at least one of input and output. For example, IO operations may comprise write requests and/or read requests directed to logical addresses of a particular logical storage volume of the storage system 102. These and other types of IO operations are also generally referred to herein as IO requests. A message, as used herein, generally includes payload data corresponding to one or more read or write requests.

Additionally, each of the host devices 101 is assumed to be implemented using at least one processing device. Each such processing device generally comprises at least one processor and an associated memory, and implements one or more functional modules for controlling certain features of the host device 101.

In the FIG. 1 embodiment, the host device 101-1 includes a disassembly module 112, a mixing module 114, and a reassembly indication module 116. The disassembly module 112, in some embodiments, slices (or partitions) individual messages associated with host device 101-1 into one or more parts. The mixing module 114 generates packets, wherein each packet includes parts from different messages, for example. The reassembly indication module 116, in some embodiments, generates and transmits a control message to the storage system 102 that includes information for reassembling the original messages from the packets, as described in more detail elsewhere herein.

It is to be appreciated that this particular arrangement of modules 112, 114, and 116 illustrated in the host device 101-1 of the FIG. 1 embodiment is presented by way of example only, and alternative arrangements can be used in other embodiments. For example, the functionality associated with the modules 112, 114, and 116 in other embodiments can be combined into a single module, or separated across a larger number of modules. As another example, multiple distinct processors can be used to implement different ones of the modules 112, 114, and 116 or portions thereof.

At least portions of modules 112, 114, and 116 may be implemented at least in part in the form of software that is stored in memory and executed by a processor.

In some embodiments, the other host devices 101-M may be implemented in a similar manner as described for host device 101-1.

In an alternative embodiment, the functionality associated with the at least portions of modules 112, 114, and 116 may be implemented by at least one processing device (not shown in FIG. 1) that is separate from each of the host devices 101. For example, the at least one separate processing device may be on a same physical security domain as the host devices 101 and may perform the functionality associated with at least a portion of modules 112, 114, and 116 with respect to messages transmitted by one or more of the host devices 101.

The storage system 102 illustratively comprises processing devices of one or more processing platforms. For example, the storage system 102 can comprise one or more processing devices each having a processor and a memory, possibly implementing virtual machines and/or containers, although numerous other configurations are possible.

The storage system 102 can additionally or alternatively be part of cloud infrastructure such as an Amazon Web Services (AWS) system. Other examples of cloud-based systems that can be used to provide at least portions of the storage system 102 include Google Cloud Platform (GCP) and Microsoft Azure.

The host devices 101 and the storage system 102 may be implemented on a common processing platform, or on two or more separate processing platforms. The host devices 101 are illustratively configured to write data to and read data from the storage system 102 in accordance with applications executing on those host devices for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The network 104 is assumed to comprise a portion of a global computer network such as the Internet, although other types of networks can be part of the network 104, including a WAN, a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The storage system 102 comprises a plurality of storage devices 106 and an associated storage controller 108. The storage devices 106 store data of a plurality of storage volumes 107. The storage volumes 107 illustratively comprise respective LUNs or other types of logical storage volumes. The term “storage volume” as used herein is intended to be broadly construed, and should not be viewed as being limited to any particular format or configuration.

The storage devices 106 of the storage system 102 illustratively comprise solid state drives (SSDs). Such SSDs are implemented using non-volatile memory (NVM) devices such as flash memory. Other types of NVM devices that can be used to implement at least a portion of the storage devices include non-volatile random access memory (NVRAM), phase-change RAM (PC-RAM), magnetic RAM (MRAM), resistive RAM, spin torque transfer magneto-resistive RAM (STT-MRAM), and Intel OptaneTM devices based on 3D XPointTM memory. These and various combinations of multiple different types of NVM devices may also be used. For example, hard disk drives (HDDs) can be used in combination with or in place of SSDs or other types of NVM devices in in the storage system 102.

It is therefore to be appreciated that numerous different types of storage devices 106 can be used in storage system 102 in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices.

In some embodiments, the storage system 102 illustratively comprises a scale-out all-flash distributed content addressable storage (CAS) system, such as an XtremIO™ storage array from Dell Technologies. A wide variety of other types of distributed or non-distributed storage arrays can be used in implementing the storage system 102 in other embodiments, including by way of example one or more Unity™ or PowerMax™ storage arrays, commercially available from Dell Technologies. Additional or alternative types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

The term “storage system” as used herein is therefore intended to be broadly construed, and should not be viewed as being limited to particular storage system types, such as, for example, CAS systems, distributed storage systems, or storage systems based on flash memory or other types of NVM storage devices. A given storage system as the term is broadly used herein can comprise, for example, any type of system comprising multiple storage devices, such as network-attached storage (NAS), SANs, direct-attached storage (DAS) and distributed DAS, as well as combinations of these and other storage types, including software-defined storage.

In some embodiments, communications between the host devices 101 and the storage system 102 comprise SCSI or Internet SCSI (iSCSI) commands. Other types of SCSI or non-SCSI commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other commands can be used in other embodiments.

For example, although in some embodiments certain commands used by the host devices 101 to communicate with the storage system 102 illustratively comprise SCSI or iSCSI commands, other embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The host devices 101 are configured to interact over the network 104 with the storage system 102. Such interaction illustratively includes generating IO operations, such as write and read requests, and sending such requests over the network 104 for processing by the storage system 102. In some embodiments, each of the host devices 101 comprises a multi-path input-output (MPIO) driver configured to control delivery of IO operations from the host device to the storage system 102 over selected ones of a plurality of paths through the network 104. The paths are illustratively associated with respective initiator-target pairs, with each of a plurality of initiators of the initiator-target pairs comprising a corresponding host bus adaptor (HBA) of the host device, and each of a plurality of targets of the initiator-target pairs comprising a corresponding port of the storage system 102.

The MPIO driver may comprise, for example, an otherwise conventional MPIO driver, such as a PowerPath® driver from Dell Technologies. Other types of MPIO drivers from other driver vendors may be used.

The storage controller 108 and the storage system 102 may further include one or more additional modules and other components typically found in conventional implementations of storage controllers and storage systems, although such additional modules and other components are omitted from the figure for clarity and simplicity of illustration.

In the FIG. 1 embodiment, the storage controller 108 includes a message assembly module 120. Generally, the message assembly module 120 obtains packets from the host devices 101, where a given one of the packets includes parts from different messages associated with at least one of the host devices 101. The message assembly module 120 reassembles the originally messages based on at least one control message that was generated by the reassembly indication module 116, as described in more detail elsewhere herein.

In an alternative embodiment, the functionality associated with the message assembly module 120 may be implemented by at least one hardware device (not shown in FIG. 1) separate from the storage system 102. For example, the at least one separate hardware device may be on a same physical security domain as the storage system 102 and may perform the functionality associated with message assembly module 120 on the packets received from the host devices 101 and forward such data to the storage system 102.

The storage system 102 in some embodiments is implemented as a distributed storage system, also referred to herein as a clustered storage system, comprising a plurality of storage nodes. Each of at least a subset of the storage nodes illustratively comprises a set of processing modules configured to communicate with corresponding sets of processing modules on other ones of the storage nodes. The sets of processing modules of the storage nodes of the storage system 102 in such an embodiment collectively comprise at least a portion of the storage controller 108 of the storage system 102. For example, in some embodiments the sets of processing modules of the storage nodes collectively comprise a distributed storage controller of the distributed storage system 102. A “distributed storage system” as that term is broadly used herein is intended to encompass any storage system that, like the storage system 102, is distributed across multiple storage nodes.

It is assumed in some embodiments that the processing modules of a distributed implementation of storage controller 108 are interconnected in a full mesh network, such that a process of one of the processing modules can communicate with processes of any of the other processing modules. Commands issued by the processes can include, for example, remote procedure calls (RPCs) directed to other ones of the processes.

The sets of processing modules of a distributed storage controller illustratively comprise control modules, data modules, routing modules and at least one management module. Again, these and possibly other modules of a distributed storage controller are interconnected in the full mesh network, such that each of the modules can communicate with each of the other modules, although other types of networks and different module interconnection arrangements can be used in other embodiments.

The management module of the distributed storage controller in this embodiment may more particularly comprise a system-wide management module. Other embodiments can include multiple instances of the management module implemented on different ones of the storage nodes. It is therefore assumed that the distributed storage controller comprises one or more management modules.

A wide variety of alternative configurations of nodes and processing modules are possible in other embodiments. Also, the term “storage node” as used herein is intended to be broadly construed, and may comprise a node that implements storage control functionality but does not necessarily incorporate storage devices.

Communication links may be established between the various processing modules of the distributed storage controller using well-known communication protocols such as TCP/IP and remote direct memory access (RDMA). For example, respective sets of IP links used in data transfer and corresponding messaging could be associated with respective different ones of the routing modules.

Each storage node of a distributed implementation of storage system 102 illustratively comprises a CPU or other type of processor, a memory, a network interface card (NIC) or other type of network interface, and a subset of the storage devices 106, possibly arranged as part of a disk array enclosure (DAE) of the storage node. These and other references to “disks” herein are intended to refer generally to storage devices, including SSDs, and should therefore not be viewed as limited to spinning magnetic media.

The storage system 102 in the FIG. 1 embodiment is assumed to be implemented using at least one processing platform, with each such processing platform comprising one or more processing devices, and each such processing device comprising a processor coupled to a memory. Such processing devices can illustratively include particular arrangements of compute, storage and network resources. As indicated previously, the host devices 101 and the storage system 102 may be implemented in whole or in part on the same processing platform or on two or more separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in geographic locations that are remote from the first geographic location. Thus, it is possible in some implementations of the system 100 for the host devices 101 and the storage system 102 to reside in two or more different data centers. Numerous other distributed implementations of the host devices 101 and the storage system 102 are also possible.

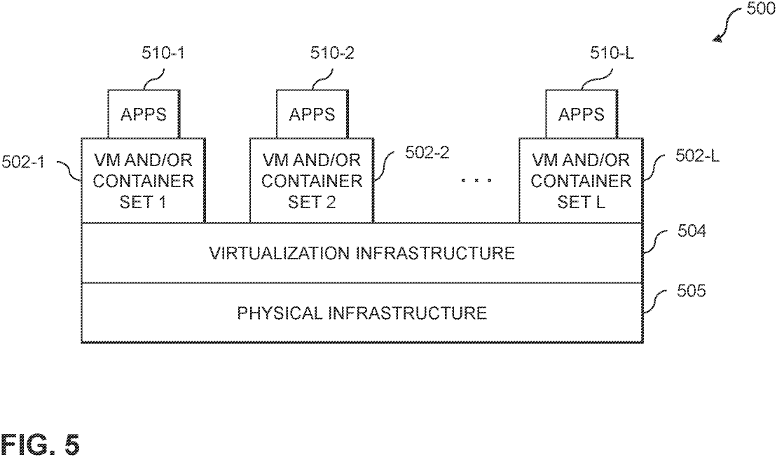

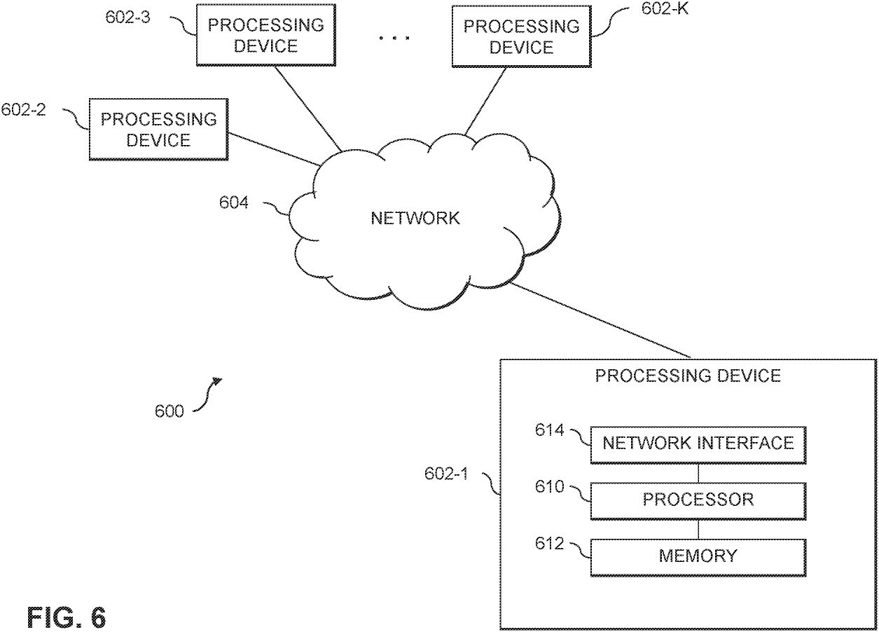

Additional examples of processing platforms utilized to implement host devices 101 and storage system 102 in illustrative embodiments will be described in more detail below in conjunction with FIGS. 5 and 6.

It is to be appreciated that these and other features of illustrative embodiments are presented by way of example only, and should not be construed as limiting in any way.

Accordingly, different numbers, types, and arrangements of system components such as host devices 101, storage system 102, network 104, storage devices 106, storage volumes 107, and storage controller 108 can be used in other embodiments.

It should be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

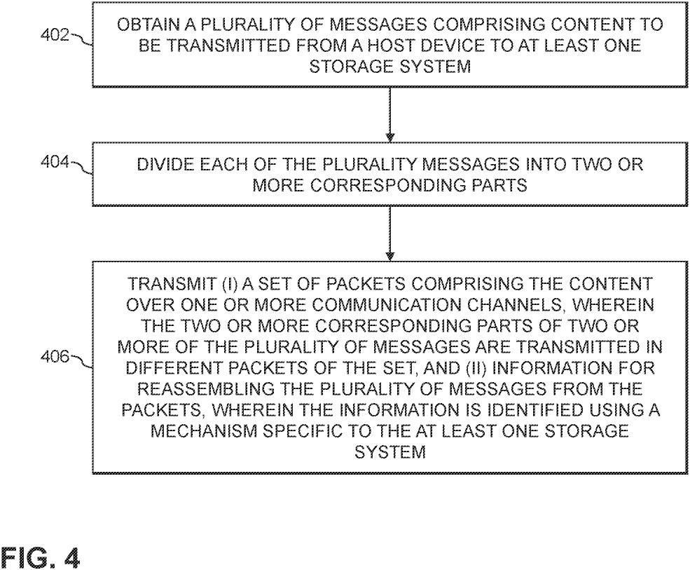

Exemplary processes utilizing modules 112, 114, and 116, will be described in more detail with reference to the flow diagram of FIG. 4.

Illustrative embodiments described herein include partitioning one or more messages into a plurality of parts (also referred to herein as slices). The slices are then dispersed across two or more packets in a randomized way, for example. Each packet may include one or more slices, which are selected randomly from multiple different messages, optionally, out of order. In at least some embodiments, every message is split regardless of the length of the message. Accordingly, the semantics or coherency associated with any particular message is effectively destroyed, thus rendering them meaningless to physical attacks such as wiretaps.

As an example, consider a SCSI write command with a payload that includes a sixteen-digit credit card number. Even if an attacker gains access to the packets, the attacker cannot reconstruct the credit card number as it is split up across different slices, which are sent to the target system in a sequencing that is random and unknown to the attacker.

In at least some embodiments, if multiple redundant paths are available, then the packets may be sent through different ones of the paths, thereby lessening the likelihood that an attacker gains access to full messages. Additionally, if the network paths are residing in different physical security domains, it would be more difficult for an attacker to gain access to packets from multiple network paths than just a single path.

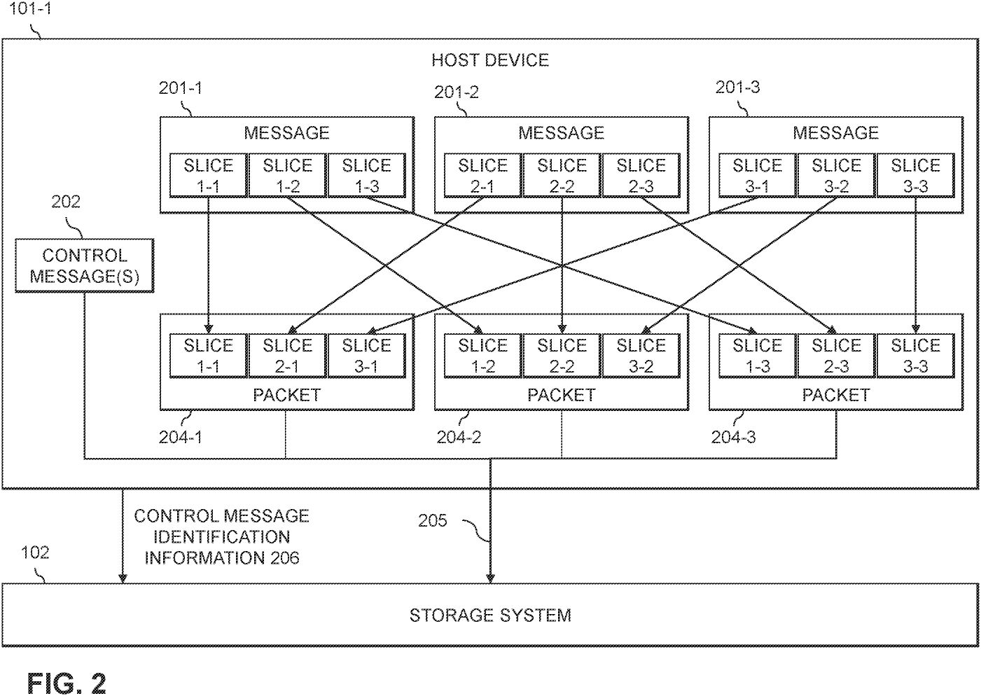

Referring now to FIG. 2, this figure shows a diagram of techniques for splitting and distributing messages across different packets in an illustrative embodiment. In the FIG. 2 example, a host device 101-1 transmits three messages 201-1, 201-2, and 201-3 (collectively referred to herein as messages 201) to the storage system 102. The disassembly module 112 of the host device 101-1 splits the content of the messages 201 into slices. More specifically, message 201-1 is split into slices 1-1, 1-2, and 1-3; message 201-2 is split into slices 2-1, 2-2, and 3-3; and message 201-3 is split into slices 3-1, 3-2, and 3-3. The mixing module 114 then mixes the slices from messages 201 into packets 204-1, 204-2, 204-3 (collectively referred to herein as packets 204). For clarity, the slices in FIG. 2 are mixed using a patterned approach (e.g., slices 1-1, 2-1, and 3-1 are mixed into packet 204-1, slices 1-2, 2-2, and 3-2 are mixed into packet 204-2, etc.); however, it is to be understood that the mixing, in other embodiments, may be purposely random to help further break up semantics or coherency of the messages 201.

FIG. 2 also depicts the host device 101-1 transmitting one or more control messages 202 to the storage system 102. The one or more control messages 202 may be generated by the reassembly indication module 116 and include information that indicates how the mixing is performed so that the messages can be reassembled by the message assembly module 120 associated with the storage system 102.

For example, the one or more control messages 202 may include information that identifies the mapping between the packets 204 (and their corresponding slices) and the messages 201. The one or more control messages 202 may be at least one of: separate from the messages 201 (as shown in the FIG. 2 example), or embedded in the packets 204, as described in more detail elsewhere herein. The packets 204 are sent over channel 205 to the storage system 102.

FIG. 2 also shows control message identification information 206 that is sent to the storage system 102. Generally, the control message identification information 206 enables the storage system 102 to identify the control messages 202. For example, the control message identification information 206 can indicate at least one signature (e.g., a sequence of two or more bits) that is used by the storage system 102 to identify the one or more control messages 202. The at least one signature can be a static (e.g., constant) signature or a rotating signature. As an example, the control message identification information 206 may include a seed value, where both the storage system 102 and the host device 101-1 are configured to derive time-synchronized signatures based on the seed value. The signature, in some examples, can be embedded into specific portions of the one or more control message 202. For example, the signature may be included in a protocol header, footer, or some other offset of the one or more control messages 202, or content blocks of the one or more control messages 202. It is to be appreciated that more complex mechanisms are also possible where both the offset of the signature and the signature vary over time.

It is also to be appreciated that the control message identification information 206 may be sent in different ways. For example, in the FIG. 2 embodiment, the control message identification information 206 is assumed to be sent via an out-of-band communication (e.g., a different, and possibly more secure channel, than channel 205). In another example, the host device 101-1 and the message assembly module 120 of the storage system 120 may be configured in an offline process so as to establish a transmission scheme that allows the one or more control messages 202 to be properly identified.

Accordingly, even if an attacker obtained all of the data sent over channel 205, the attacker would still need the control message identification information 206 to identify the one or more control messages 202 in order to reassemble the original messages 201.

The message assembly module 120 associated with the storage system 102 accumulates the packets 204 and, optionally, the one or more control messages 202 as they are received. In response to determining that each of the packets 204 have been received (e.g., based on the one or more control messages 202 and the control message identification information 206), the message assembly module 120 reassembles the slices into the original messages 201 and forwards them to the target element of the storage system 102, such as a storage array or some other storage element, for example.

Some embodiments also include applying at least one encryption technique to the data corresponding to the messages 201 transmitted by the host device 101-1 and/or the channel 205 that is used to transmit the packets 204. As such, each of the packets 204, its corresponding component slices, and the one or more control messages 202 may be encrypted, thus providing an additional layer of security.

FIG. 2 shows the functionality of the modules 112, 114, and 116 performed at the host device 101-1 and the functionality of the message assembly module 120 being performed at the storage system 102, however, this is not intended to be limiting. More generally, the message assembly module 120 may be placed within a physical security domain where a physical attack cannot be deployed, such as within the target storage element or array, or a data center corresponding to the storage system 102, for example. Similarly, modules 112, 114, and 116 may be deployed in the same physical security domain as the host device 101-1, including within the host device 101-1, for example.

It is to be appreciated that if a physical attack is attempted (e.g., via a splitter or injector attack) when the packets 204 are being transmitted from the host device 101-1 to the storage system 102, any packets 204 that are collected by the attacker would be rendered useless as the attacker would not know how to assemble the packets 204 in a consistent and/or semantically meaningful way.

Exemplary techniques that can be implemented by the reassembly indication module 116 to generate control messages (e.g., control messages 202) and/or embed control information into packets are now described in more detail. It is noted that the control messages and/or the embedded control information can be identified by using a particular mechanism based on the control message identification information 206, for example.

Consider an example where each message has a corresponding unique identifier, and a message M1 is split into three slices S1, S2, and S3, where the unique identifier of M1 is ID1. In at least some embodiments, ID1 and an ordering identifier are embedded into each of the slices S1, S2, and S3. The ordering identifiers indicate that slice S1 is “1 out of 3,” slice S2 is “2 out of 3,” and slice S3 is “3 out of 3,” for example. The unique identifier and the ordering identifier may be embedded into specific portions (e.g., at a particular offset) of each slice, in a similar manner as described above in conjunction with the one or more control messages 202 and the control message identification information 206. The message assembly module 120 accumulates the slices from different packets (e.g., in a receive buffer), and then performs a lookup for each slice, where the lookup key is the message identifier of the corresponding message (e.g., ID1 for message M1).

As such, the message assembly module 120 may group the slices based on the unique identifier ID1, and then reassemble the slices S1, S2, and S3 in the order specified by the embedded ordering identifiers to obtain the original message M1, which is then delivered up the stack.

As another example, the reassembly indication module 116 may generate unique slice identifiers (SID) for each slice. In such an example, the reassembly indication module 116 may assign SID1 to S1, SID2 to S2, and SID3 to S3, send a separate control message (e.g., control message 202) that includes an indication that ID1 of message M1 includes the slices corresponding to SID1, SID2, and SID3, and also send an indication that specifies the order in which the slices are to be reassembled.

The message assembly module 120 accumulates packets and waits for a control message from the reassembly indication module 116. In response to receiving a control message, the message assembly module 120 extracts the SIDs and uses them as lookup keys. If the control message arrives prior to the dependent slices, then the message assembly module 120 may delay reassembling the message until the slices corresponding to the control message arrived.

When the corresponding control messages have arrived, the message assembly module 120 reassembles the slices in the order specified in the control message, and delivers the reassembled message up the stack.

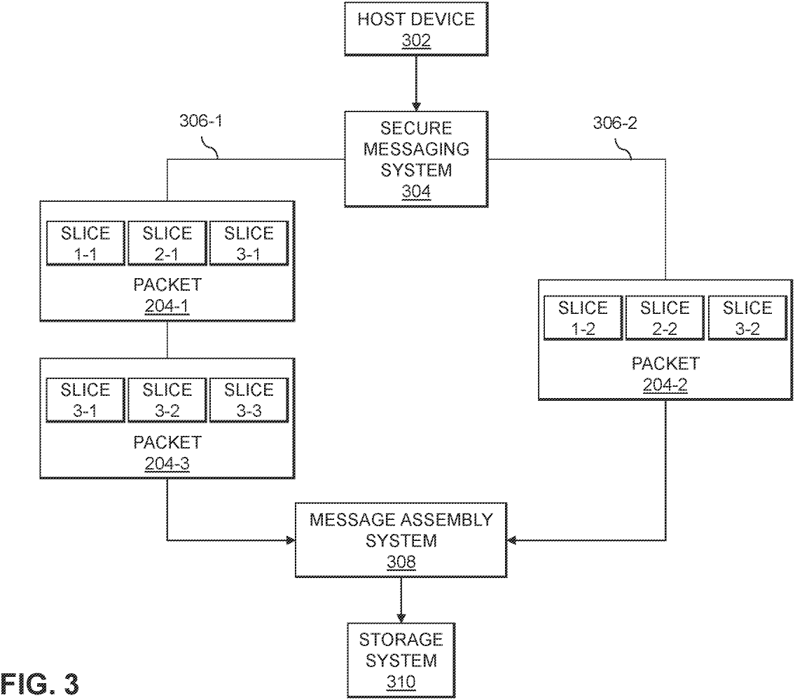

Referring now to FIG. 3, this figure shows a diagram of techniques for distributing packets across multiple network paths in an illustrative embodiment. In the example shown in FIG. 3, it is assumed that a secure messaging system 304 comprises at least one processing device that is separate from a host device 302. More specifically, it is further assumed that the secure messaging system 304 includes modules 112, 114, and 116, and is placed in the same physical security domain as the host device 302. Although it is to be appreciated that in other embodiments, the modules 112, 114, and 116 may be implemented by host device 101-1 (as is assumed in FIG. 2, for example). Also shown in FIG. 3 is a message assembly system 308. The message assembly system 308 is assumed to comprise the message assembly module 120, but is implemented separately from the storage system 310. It is further noted that the control messages 202 are not explicitly shown in FIG. 3, but may be sent in a similar manner as described in conjunction with FIG. 2, for example.

In contrast to FIG. 2, the packets 204 are transmitted over multiple network paths 306-1, 306-2 between the secure messaging system 304 and the message assembly system 308. By doing so, the order of the slices in the packets 204 are further obfuscated, thereby reducing the likelihood that the slices can be reconstructed into their original messages 201 by an attacker. The use of multiple network paths 306-1, 306-2 also reduces the likelihood of a successful physical attack as the attack targets are diversified across multiple networks, potentially spread across different security domains.

Accordingly, embodiments described herein may utilize a zero-knowledge architecture for storage network messages (e.g., SAN messages), without having to distribute the data itself. Moreover, at least some embodiments are configured to at least one of: prevent a single point of physical attack from enabling the theft of all messaging; add additional layers of security on top of encryption techniques; and thwart wiretapping attacks and other types of attacks that rely on physical access to a machine; reduce the need for other, costly physical security measures; and increase security effectiveness.

FIG. 4 is a flow diagram of a process for securing data transmissions using split messages in an illustrative embodiment. It is to be understood that this particular process is only an example, and additional or alternative processes can be carried out in other embodiments.

In this embodiment, the process includes steps 402 through 406. These steps are assumed to be performed by a host device 101-1 (or another device within the same physical security domain as the host device 101-1) utilizing its modules 112, 114 and 116.

Step 402 includes obtaining a plurality of messages comprising content to be transmitted from a host device to at least one storage system. Step 404 includes dividing each of the plurality messages into two or more corresponding parts. Step 406 includes transmitting (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system.

The two or more corresponding parts of the two or more of the plurality of messages may be randomly assigned to the packets in the set. The set of packets may be transmitted over two or more of the communication channels. The information may identify an order that the two or more parts corresponding to a given one of the plurality messages are to be reassembled by at least one recipient device associated with the at least one storage system. The information may be transmitted separately from the set of packets. The information may include: a message identifier of the given message; and a respective part identifier for each of the two or more corresponding parts of the given message, and the at least one recipient device may derive the order based at least in part on the respective part identifiers. The process may include a step of embedding the information corresponding to the given message within the two or more corresponding parts. The information embedded within a given one of the two or more corresponding parts may include a message identifier of the given message and an order identifier of the given part. The mechanism identifying the information may comprise an offset associated with one or more of: a given one of the packets and a given part in the set. The mechanism may include at least one signature. The mechanism may be established based on an out-of-band communication.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement host devices and storage systems with functionality for securing data transmission with split messages will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2, ... 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, ... 510-L running on respective ones of the VMs/container sets 502-1, 502-2, ... 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. Such implementations can provide functionality for securing transmission in a storage system of the type described above using one or more processes running on a given one of the VMs. For example, each of the VMs can implement modules 112, 114, and 116 and/or other components for implementing functionality for securing transmissions in the storage system 102.

A hypervisor platform may be used to implement a hypervisor within the virtualization infrastructure 504. Such a hypervisor platform may comprise an associated virtual infrastructure management system. The underlying physical machines may comprise one or more distributed processing platforms that include one or more storage systems.

In other implementations of the FIG. 6 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such implementations can also provide functionality for securing transmission in a storage system of the type described above. For example, a container host device supporting multiple containers of one or more container sets can implement one or more instances of the modules 112, 114, and 116, and/or other components for implementing functionality for securing transmissions in the storage system 102.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, ... 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 612 may comprise RAM, read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure such as VxRail™, VxRack™, VxRack™ FLEX, VxBlock™, or Vblock® converged infrastructure from Dell Technologies.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more components for securing transmission by splitting messages of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, host devices, storage systems, storage devices, storage controllers, and other components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining a plurality of messages comprising content to be transmitted from a host device to at least one storage system;
dividing each of the plurality messages into two or more corresponding parts; and
transmitting (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system;
wherein the method is performed by at least one processing device comprising a processor coupled to a memory.

2. The computer-implemented method of claim 1, wherein the two or more corresponding parts of the two or more of the plurality of messages are randomly assigned to the packets in the set.

3. The computer-implemented method of claim 1, wherein the set of packets is transmitted over two or more of the communication channels.

4. The computer-implemented method of claim 1, wherein the information identifies an order that the two or more parts corresponding to a given one of the plurality messages are to be reassembled by at least one recipient device associated with the at least one storage system.

5. The computer-implemented method of claim 4, wherein the information is transmitted separately from the set of packets.

6. The computer-implemented method of claim 5, wherein the information comprises:
a message identifier of the given message; and
a respective part identifier for each of the two or more corresponding parts of the given message, wherein the at least one recipient device derives the order based at least in part on the respective part identifiers.

7. The computer-implemented method of claim 4, further comprising:
embedding the information corresponding to the given message within the two or more corresponding parts.

8. The computer-implemented method of claim 7, wherein the information embedded within a given one of the two or more corresponding parts comprises a message identifier of the given message and an order identifier of the given part.

9. The computer-implemented method of claim 1, wherein the mechanism identifying the information comprises at least one signature, and wherein the at least one signature is established based on an out-of-band communication.

10. A non-transitory processor-readable storage medium having stored therein program code of one or more software programs, wherein the program code when executed by at least one processing device causes the at least one processing device:
to obtain a plurality of messages comprising content to be transmitted from a host device to at least one storage system;
to divide each of the plurality messages into two or more corresponding parts; and
to transmit (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system.

11. The non-transitory processor-readable storage medium of claim 10, wherein the two or more corresponding parts of the two or more of the plurality of messages are randomly assigned to the packets in the set.

12. The non-transitory processor-readable storage medium of claim 10, wherein the set of packets is transmitted over two or more of the communication channels.

13. The non-transitory processor-readable storage medium of claim 10, wherein the information identifies an order that the two or more parts corresponding to a given one of the plurality messages are to be reassembled by at least one recipient device associated with the at least one storage system.

14. The non-transitory processor-readable storage medium of claim 13, wherein the information is transmitted separately from the set of packets.

15. The non-transitory processor-readable storage medium of claim 14, wherein the information comprises:
a message identifier of the given message; and
a respective part identifier for each of the two or more corresponding parts of the given message, wherein the at least one recipient device derives the order based at least in part on the respective part identifiers.

16. The non-transitory processor-readable storage medium of claim 13, wherein the program code further causes the at least one processing device:
to embed the information corresponding to the given message within the two or more corresponding parts.

17. An apparatus comprising:
at least one processing device comprising a processor coupled to a memory;
the at least one processing device being configured:
to obtain a plurality of messages comprising content to be transmitted from a host device to at least one storage system;
to divide each of the plurality messages into two or more corresponding parts; and
to transmit (i) a set of packets comprising the content over one or more communication channels, wherein the two or more corresponding parts of two or more of the plurality of messages are transmitted in different packets of the set, and (ii) information for reassembling the plurality of messages from the packets, wherein the information is identified using a mechanism specific to the at least one storage system.

18. The apparatus of claim 17, wherein the two or more corresponding parts of the two or more of the plurality of messages are randomly assigned to the packets in the set.

19. The apparatus of claim 17, wherein the set of packets is transmitted over two or more of the communication channels.

20. The apparatus of claim 17, wherein the information identifies an order that the two or more parts corresponding to a given one of the plurality messages are to be reassembled by at least one recipient device associated with the at least one storage system.
